(19) United States
(12) Patent Application Publication
(10) Pub. No.: US 2006/0072710 A1
(43) Pub. Date: Apr. 6, 2006

(54) Methods, systems, and computer program products for providing emergency information

(76) Inventors: Thomas P. Breen, Snellville, GA (US); William Marczak, Decatur, GA (US)

Correspondence Address: CANTOR COLBURN LLP - BELLSOUTH, 55 GRIFFIN ROAD SOUTH, BLOOMFIELD, CT, 06002, US

(21) Appl. No.: 11/128,449

(22) Filed: May 13, 2005

Related U.S. Application Data
(60) Provisional application No. 60/616,477, filed on Oct. 6, 2004.

(51) Int. Cl. H04M 11/04

(52) U.S. Cl. 379/45; 379/37

(57) ABSTRACT

Methods, systems, and computer program products for providing emergency information. Methods include providing emergency information to a requestor including receiving a request from the requestor requesting emergency information. An automatic number identification (ANI) is determined in response to the request and a database accessed. The emergency information is retrieved from the database in response to the ANI and provided to the requestor.

### CROSS REFERENCE TO RELATED APPLICATIONS

This application claims the benefit of U.S. provisional patent application Ser. No. 60/616,477, filed Oct. 6, 2004, the entire contents of which are incorporated herein by reference.

### BACKGROUND

Public safety offices use data from an automatic location identification (ALI) database to determine the location of a caller placing an emergency call (e.g., a 911 call). Existing systems receive a call at a public safety answering point (PSAP) such as a police station and retrieve ALI information from an ALI database. Records in the ALI database may be accessed, for example, based on the caller's phone number from where the call was placed. The caller's phone number may be determined based on an automatic number identification (ANI) that is commonly used in caller identification systems.

Currently, there is no system for an individual to access their emergency information, such as ALI information. An individual has no way of knowing whether the location information in the ALI database is accurate. Thus, there is a need in the art for a system for allowing an individual to access and confirm stored emergency information.

### SUMMARY

Exemplary embodiments relate to methods, systems, and computer program products for providing emergency information. Methods include providing emergency information to a requester including receiving a request from the requestor requesting emergency information. An automatic number identification (ANI) is determined in response to the request and a database accessed. The emergency information is retrieved from the database in response to the ANI and provided to the requestor.

Methods include a method of providing information comprising receiving a request from the requester, the request including an identity of the requestor and a password. The identity of the requestor is verified based on the identity and the password. An automatic location identification (ALI) database is accessed for records associated with the requestor and the records provided to the requestor.

Systems include a system for providing emergency information to a requestor comprising a query engine receiving a request from the requestor requesting emergency information. The query engine determines an automatic number identification (ANI) in response to the request. The query engine accesses a database and retrieves the emergency information from the database in response to the ANI. The query engine provides the emergency information to the requestor.

Other systems, methods, and/or computer program products according to exemplary embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

Referring now to the drawings wherein like elements are numbered alike in the several FIGURES:

FIG. 1 is a block diagram of an exemplary system for providing emergency information.

FIG. 2 is a flowchart of an exemplary process for providing emergency information.

### DETAILED DESCRIPTION OF EXEMPLARY EMBODIMENTS

Exemplary embodiments of the invention provide methods, systems and computer program products for providing emergency information, such as ALI information, to a requestor. Exemplary embodiments involve an individual user accessing their own ALI information pertinent to their own location information. Other embodiments involve a provider of services (e.g., a wireless communications provider) retrieving ALI information based on pseudo-ANI (pANI) records. A number of applications exist for embodiments of the invention and the invention is not limited to the embodiments discussed herein.

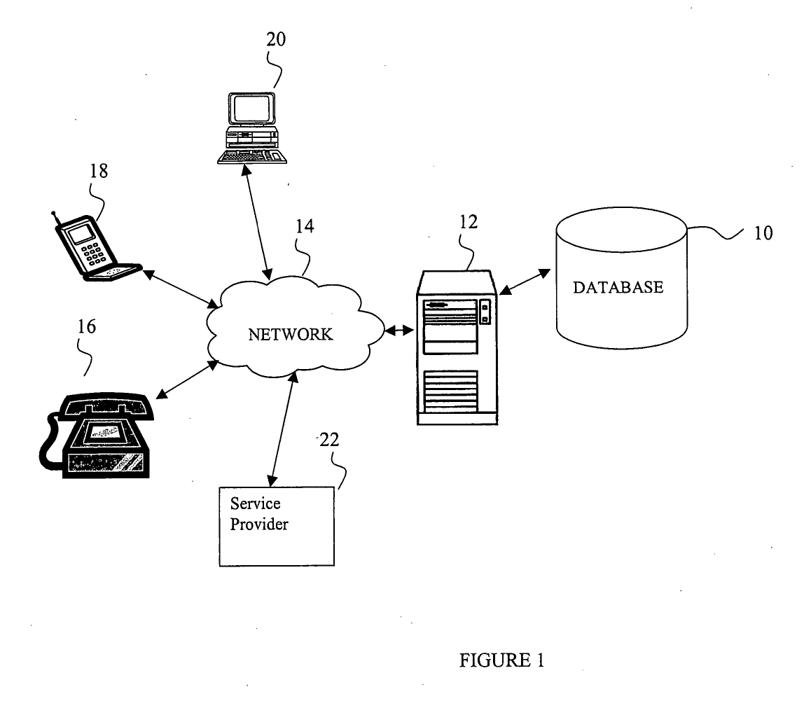

FIG. 1 is a block diagram of a system for providing emergency information to a requestor. The system includes a database 10 that includes ALI information along with other emergency information. Database 10 may be, for example, an actual E9-1-1 ALI-DB or an exact copy of the ALI-DB, or a third party database management system (DBMS) that is responsible for entering records into the actual ALI-DB.

Database 10 is not limited to 911 and E911 ALI information. Database 10 may include a variety of other types of emergency information. For example, database 10 may include location information maintained by a commercial health and safety monitoring entity (e.g., LifeAlert) such as location, medical information (known conditions, allergies), etc. Database 10 may include information from an alarm monitoring system location such as location information, emergency contact information, etc. Thus, emergency information includes 911 ALI information and other types of information.

A query engine 12 accesses database 10 in response to a request from a requestor. Query engine 12 may be implemented using one or more servers executing a computer program stored on a computer program product accessible by the server. As described in more detail herein, the query engine receives a request from a requestor, extracts the relevant parameter from the request, accesses the database 10 and returns the result to the requestor. As described further herein, options may also be presented to the requestor to confirm whether the emergency information from the database 10 is accurate.

The query engine 12 is connected to a communications network 14, which is represented generally in FIG. 1. The communications network 14 may include a number of different types of networks include wireline (e.g., POTS), wireless, VoIP, etc. Different types of networks process requests in different manners and generate different request parameters. For example, a call from a home phone on POTS generates an ANI. Query engine 12 extracts the ANI call parameter and uses this call parameter to access the database 10 and return the database results to the requestor. Query engine 12 also extracts call parameters based on requests made in different formats, such as wireless calls, that generate a pANI and VoIP calls, that generate a caller identifier.

The requestors accessing network 14 may vary. As shown in FIG. 1, requestors include wireline phones 16, wireless phones 18, VoIP communication devices 20 and service providers 22. Each of these requestors generates request parameters that are processed by the query engine 12 to access emergency information from database 10.

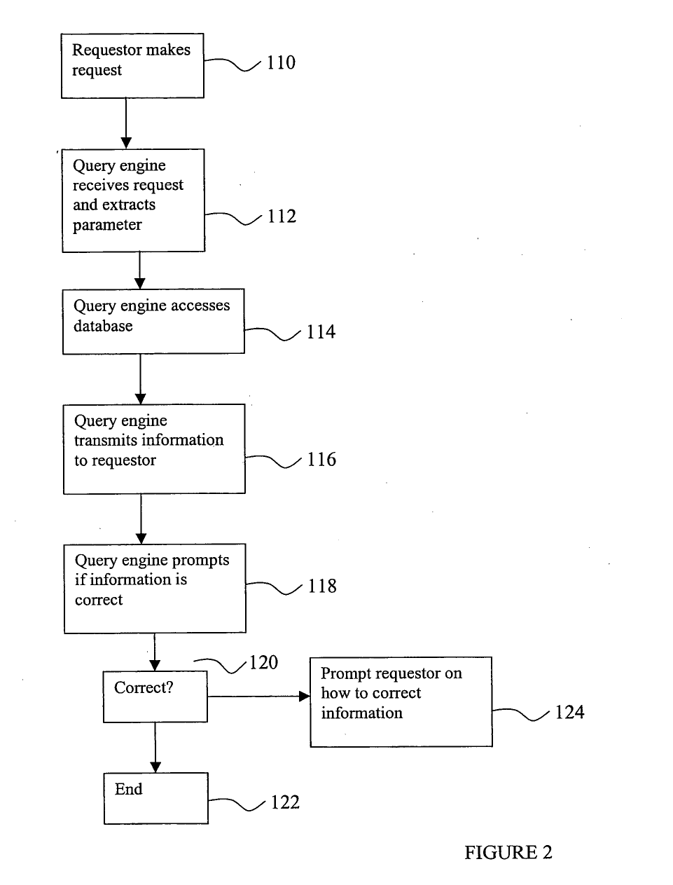

FIG. 2 is a flowchart of a process of responding to a request for emergency information from a requestor executed by the query engine 12. The process begins at step 110 where a requestor makes a request for emergency information. The requestor may dial a designated phone number to access the emergency information retrieval service. The network identifies the number called and provides request parameters to the query engine 12. The call parameters for different requestors are discussed in further detail herein.

At step 112, the query engine 12 receives the request and uses one or more request parameters to access information from database 10. For example, for a wireline call from phone 16, the request parameter may be the ANI that includes the calling party number (CPN). This number is used to retrieve the emergency information (e.g., address corresponding to the CPN). The query engine 12 accesses database 10 at step 114 and forwards a response to the requestor at 116. Responses could be a normal response that includes the expected data, such as an address, etc. A no record found (NRF) response is returned whenever the response parameter is not found in the searched database. A request failure response is returned whenever the request parameter is not received at the query engine 12.

An NRF response may be designed to automatically raise a flag for the database provider to research the request parameter to determine why this parameter is not in database 10. This is especially valuable in the case of an E9-1-1 ALI-DB, where the expectation is that any number that could have dialed the access number should be loaded in the E9-1-1 ALI-DB serving that customer.

Other responses may be generated in response to the request parameter. For example, if the request originates through a PBX the location information may be provided along with a message that the request originated from a PBX and the location information corresponds to the location of the PBX. This may be different than the location of the request placing the call.

At step 118, the query engine 12 prompts the user whether the emergency information is accurate. For example, the query engine may generate a message stating press 1 if the information is correct, press 2 if the information is not correct. If the information is correct, as indicated by the requestor at step 120, the process ends at step 122. If the information is incorrect at step 120, flow proceeds to step 124 where the requestor is given information on how to correct the emergency information in database 10. This may entail providing the requester with a phone number to call and providing the requestor with a confirmation code.

Different requestors provide different types of request parameters. A call from a wireline phone 16 from an individual's residence may generate a request parameter that include the phone number from which the call was made. This allows anyone to dial a designated number(s) to validate their own address as stored in database 10, based upon the value contained in the Calling Party Number (CPN) parameter of the SS7 Initial Address Message (IAM), which corresponds to the ANI in many cases. Those skilled in the art will recognize that industry standards exist to describe the details of the SS7 network parameters and how it is used to process most Public Switched Telephone Network (PSTN) calls made today. Thus, the ANI is used as the request parameter by query engine 12. The requestor can then verify that their home address is correct in database 10.

The requestor may also be using a wireless device 18 (phone, PDA, etc.). In this situation, the requestor dials the designated number and the network 14 forwards the call and request parameters to query engine 12. The request parameter includes the mobile directory number (MDN) for the wireless device from which the wireless call originated. The query engine 12 accesses database 10 using the MDN to retrieve location information identified for the cell tower.

The requestor may submit the request using packet-based communications, such as VoIP as represented by computer 20. Other packet-based communications may be used (e.g., RoIP) to submit the request for emergency information. Industry standards also exist for packet-based communications such as VoIP technology, which are used instead of the SS7 or PSTN to accomplish the same type of query. This function is also applicable in a Packet technology environment, where the calling party identifier is used to the query database 10.

The designated number(s) could also be used by service providers to validate their records in database 10. For example, a service provider may be a wireless service provider (WSP) wishing to check pANI records associated with that provider. The service provider may call an alternate designated number and enter an authorization code (e.g., PIN) to verify the identity of the party accessing the database 10. To do so, the WSP calls a designated number and submits pANI numbers associated with that provider. The use of the query engine 12 is not limited to WSPs. Embodiments may include other types of service providers 22, such as, but not limited to, VoIP service providers, and PBX operators.

Embodiments provide the address listed in database 10 based upon the ANI number presented by the requestor, either automatically generated through network 14 or submitted by the requestor (e.g., a service provider entering pANI numbers). Other information from database 10 may be provided to the requester. For example, name or other data may be provided to the requestor. The emergency information may include other information such as location of servicing fire department (e.g., alarm monitoring customers), emergency contact information (e.g., medical emergency monitoring customers), etc.

The service may be provided at no charge to the requestor to avoid security and billing issues typically associated with pay per use services. Cost recovery could be accomplished through 911 tariffs by billing the Public Safety Answering Point (PSAP) and/or the service providers as applicable. The term PSAP is used generically to include the agencies responsible for providing E9-1-1 services to the public in any given community. Alternately, this service may be provisioned as a “pay per use” service for other commercial location based services.

Embodiments provide the opportunity to allow any network that is so equipped, to provide estimated or precise location data in the form of longitude and latitude (expressed generically as x & y respectively) via the SS7 IAM, using the industry standard Geodetic Location Parameter (GLP). The receiving database 10 uses the x, y data as the request parameter (when present) rather than or in addition to the ANI/pANI/id token to look up the associated address (and other data if applicable and permitted). The applicable gathered data would be returned to the requester. In the case of a response derived by x, y values, the address returned to the caller would be representative of the closest known address to the coordinates used in the query, or alternatively the response could be some other information, such as the nearest businesses of interest, hospitals, police stations, etc.

Commercial location services may be located on advanced intelligent network (AIN) accessible (or equivalent) database platforms, such as an SCP (Service Control Point). These would not use an actual E9-1-1 ALI-DB, but instead would include, or have access to, other non E9-1-1 databases.

As described above, embodiments may be in the form of computer-implemented processes and apparatuses for practicing those processes. In exemplary embodiments, the invention is embodied in computer program code executed by one or more network elements. Embodiments include computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. Embodiments include computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the claims.

What is claimed is:

1. A method of providing emergency information to a requestor, the method comprising:
receiving a request from the requester requesting emergency information;
determining an automatic number identification (ANI) in response to the request;
accessing a database;
retrieving emergency information from the database in response to the ANI;
providing the emergency information to the requestor.

2. The method of claim 1 wherein:
the database is an automatic location identification (ALI) database.

3. The method of claim 2 wherein:
the emergency information from the ALI database is location information associated with the ANI provided to a public safety answering point (PSAP) and associated with an E9-1-1 call.

4. The method of claim 1 wherein:
the request is received from a telephone.

5. The method of claim 1 wherein:
the request is generated from a personal digital assistant, or other voice or data communications device.

6. The method of claim 1 further comprising:
prompting the requestor to confirm that the emergency information is accurate.

7. The method of claim 6 further comprising:
providing the requestor with a course of action if the emergency information is not accurate.

8. The method of claim 1 wherein:
the ANI is a pseudo-ANI (pANI).

9. The method of claim 8 wherein:
the emergency information is location information associated with the pANI provided to a public safety answering point (PSAP).

10. The method of claim 1 wherein:
the emergency information includes a notification that the ANI is associated with a Private Branch Exchange (PBX).

11. A method of providing information comprising:
receiving a request from the requestor, the request including an identity of the requestor and a password;
verifying the identity of the requestor based on the identity and the password;
accessing an automatic location identification (ALI) database for records associated with the requestor;
providing the records to the requestor.

12. The method of claim 11 wherein:
the identity is determined from an automatic number identification (ANI).

13. The method of claim 11 wherein:
the identity is entered by the requester.

14. A system providing emergency information to a requestor, the system comprising:
a query engine receiving a request from the requestor requesting emergency information;
the query engine determining an automatic number identification (ANI) in response to the request;
the query engine accessing a database;
the query engine retrieving the emergency information from the database in response to the ANI;
the query engine providing the emergency information to the requester.

15. The system of claim 14 wherein:
the database is an automatic location identification (ALI) database.

16. The system of claim 15 wherein:
the emergency information from the ALI database is location information associated with the ANI provided to a public safety answering point (PSAP) and associated with an E9-1-1 call.

17. The system of claim 14 wherein:
the query engine prompts the requestor to confirm that the emergency information is accurate and provides the requestor with a course of action if the emergency information is not accurate.

18. The system of claim 14 wherein:
the ANI is a pseudo-ANI (pANI).

19. The system of claim 18 wherein:
the emergency information is location information associated with the pANI provided to a public safety answering point (PSAP).

20. The system of claim 14 wherein:
the emergency information includes a notification that the ANI is associated with a Private Branch Exchange (PBX).
